(19) United States
(12) Patent Application Publication
(10) Pub. No.: US 2002/0130204 A1
(43) Pub. Date: Sep. 19, 2002

(54) Prostrate water sprinkler

(76) Inventor: Hui-Chen Chao, Chan Hua Hsien (TW)

Correspondence Address: HARRISON & EGBERT, Suite 100, 1018 Preston St., Houston, TX, 77002, US

(21) Appl. No.: 09/801,577

(22) Filed: Mar. 9, 2001

(51) Int. Cl. B05B 1/14

(52) U.S. Cl. 239/548; 239/556; 239/566; 239/587.1; 239/589

(57) ABSTRACT

A prostrate water sprinkler comprises a base on which one or more spray tubes are disposed. The spray tubes are provided with a plurality of jet nozzles which are arranged in one or two rows along the longitudinal direction of the spray tubes. The jet nozzles can be adjusted in spray angle thereof by an adjustment member which is mounted on the spray tubes.

### BACKGROUND OF THE INVENTION

1. Field of the Invention

The present invention relates generally to a gardening implement, and more particularly to a prostrate lawn sprinkler.

2. Description of Related Art

The conventional prostrate lawn sprinkler comprises only one spray tube, which is provided with a plurality of jet nozzles for emitting water and can be adjusted in spray pattern. In light of being equipped with only one spray tube, the conventional prostrate lawn sprinkler is not efficient at best.

### BRIEF SUMMARY OF THE INVENTION

The primary objective of the present invention is to provide a prostrate water sprinkler free of the shortcoming of the conventional prostrate water sprinkler described above.

The prostrate water sprinkler of the present invention comprises a base on which two or more spray tubes are mounted. The spray tubes are provided with a plurality of jet nozzles which are different in water-emitting angle to promote the water-spraying efficiency of the present invention.

The objective, features, and functions of the present invention will be more readily understood upon a thoughtful deliberation of the following detailed description of the present invention with reference to the accompanying drawings.

### BRIEF DESCRIPTION OF THE SEVERAL VIEWS OF THE DRAWINGS

FIG. 1 shows a perspective view of the present invention.

FIG. 2 shows an exploded view of the present invention.

FIG. 3 shows a sectional schematic view of the spray tubes of the present invention in action.

FIGS. 4A-4D are sectional schematic views of a control valve of the present invention in action.

FIGS. 5A-5E are sectional schematic views of the spray tubes of the present invention in action.

### DETAILED DESCRIPTION OF THE INVENTION

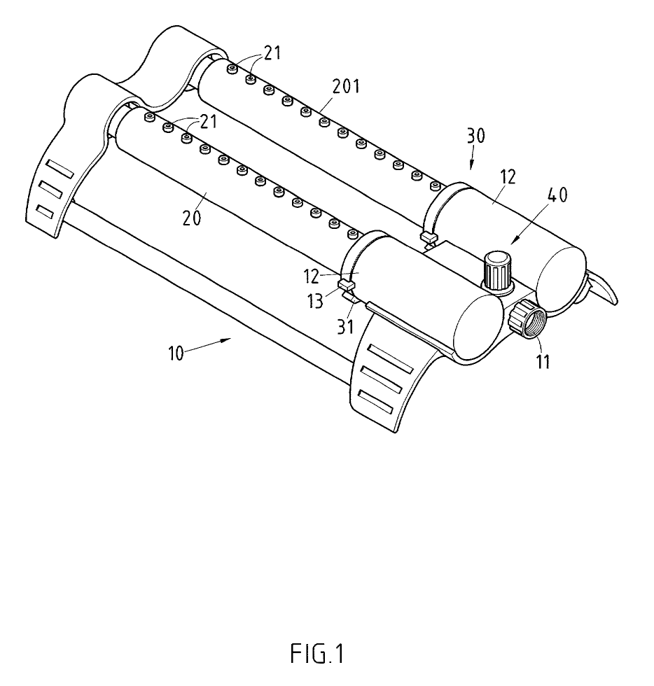

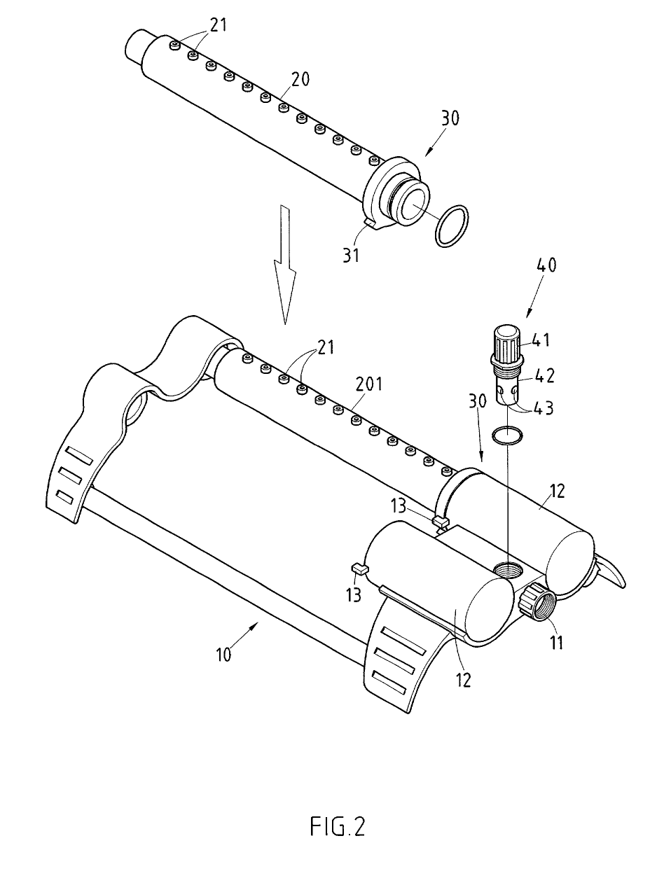

As shown in FIGS. 1 and 2, a prostrate water sprinkler of the present invention comprises a base 10 and two spray tubes 20 and 201.

The base 10 is provided at one end with a hose connector 11 and two locating members 12. The hose connector 11 is in communication with the spray tubes 20 and 201. The two locating members 12 are intended to locate the spray tubes 20 and 201, which are mounted on the base 10. The locating members 12 are provided in the inner end thereof with a stop block 13 extending therefrom.

The spray tubes 20 and 201 are similar in construction and are provided with a plurality of jet nozzles 21 which are arranged in a row along the longitudinal direction thereof. The spray tubes 20 and 201 are further provided at one end with an adjustment member 30 which is in turn provided with a lug 31 corresponding in location to the stop block 13 of the locating members 12. The adjustment member 30 is mounted on one end of the spray tubes 20 and 201. The spray tubes 20 and 201 are located on the base 10 by the locating members 12 such that the lug 31 of the adjustment member 30 is corresponding in location to the stop block 13 and can be stopped by the stop block 13. The adjustment member 30 is intended to adjust the spray angle of the jet nozzles 21 of the spray tube 20 or 201. The stop block 13 of the locating members 12 and the lug 31 of the adjustment member 30 are intended to confine the adjustment of spray angle of the spray tubes 20 and 201. In other words, the rotational angle of the spray tube 20 or 201 is confined by the lug 31 of the adjustment member 30 and the stop block 13 of the locating member 12.

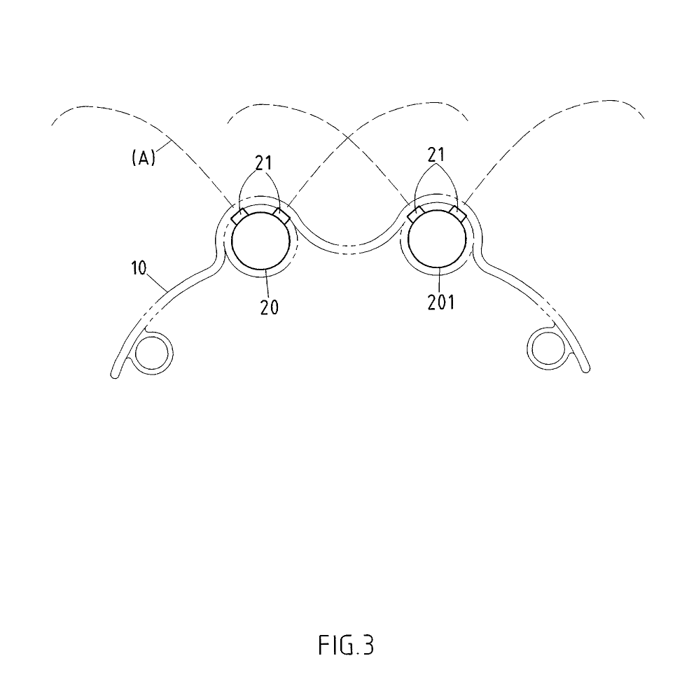

As illustrated in FIG. 3, the spray tubes 20 and 201 of the present invention are provided with a plurality of jet nozzles 21 which are arranged in two rows along the longitudinal direction thereof. The jet nozzles of one row of the spray tube are different in spray angle from the jet nozzles of another row of the same spray tube, as illustrated by the dotted curves “A”. In light of such an arrangement of jet nozzles, the watering efficiency of the present invention is greatly improved.

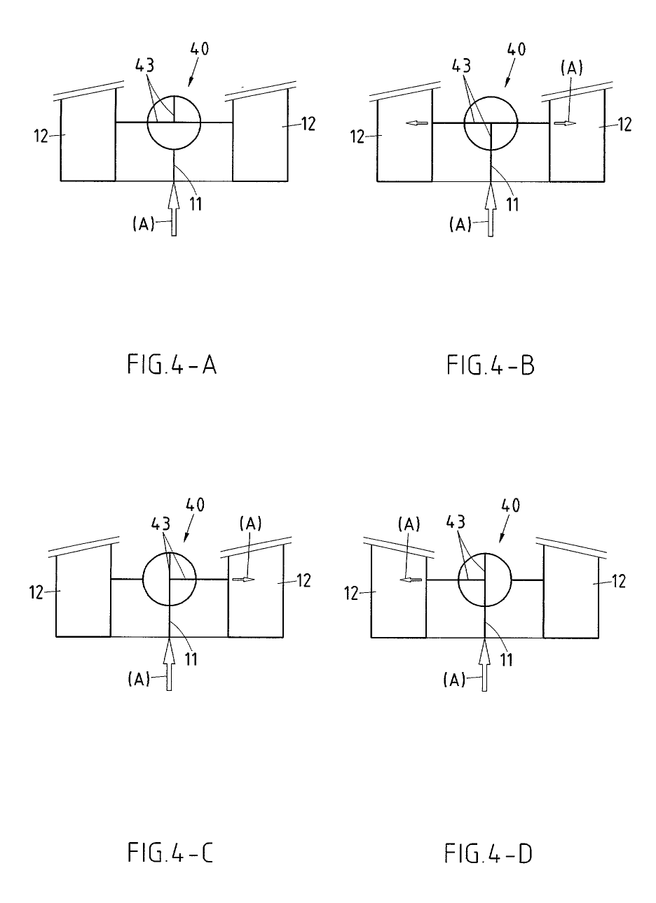

The base 10 of the present invention is further provided at one end with a water-distributing valve 40 in communication with the hose connector 11 and the spray tubes 20 and 201. As shown in FIGS. 4A-4D, the water-distributing valve 40 controls the distribution of water (A) to the spray tubes 20 and 201. The valve 40 has a knob 41 and a water-distributing rod 42 which is provided with two distribution holes 43, as shown in FIG. 2. As a result, the water (A) can be distributed to only one spray tube or two spray tubes at the same time. The supply of the water (A) to the spray tubes can be completely terminated by the valve 40, as shown in FIG. 4A.

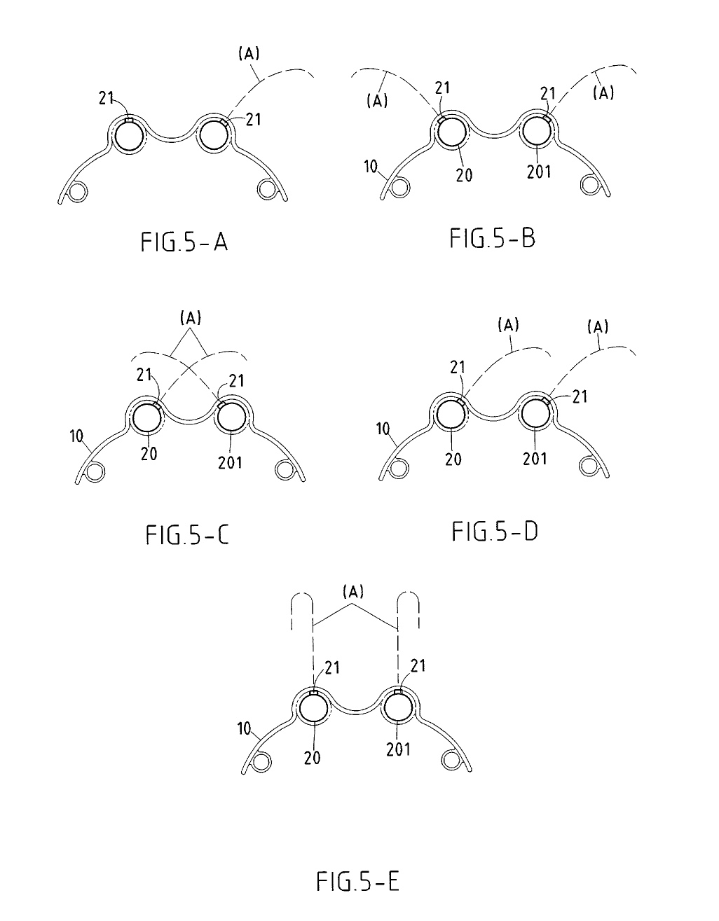

In view of the spray tubes 20, 201, the specific arrangement of the jet nozzles 21 and the spray tubes 20 and 201, the adjustment members 30, and the water distributing valve 40, the prostrate water sprinkler of the present invention is capable of various spray patterns, as illustrated in FIGS. 5A-5E.

I claim:

1. A prostrate water sprinkler comprising:
a base provided at one end with a hose connector and two locating members mounted thereon at an interval; and
two spray tubes mounted at an interval on said base such that said spray tubes are in communication with said hose connector, and that said spray tubes are located on said base by said two locating members whereby said two spray tubes are provided with a plurality of jet nozzles which are arranged in a row along a longitudinal direction thereof, said two spray tubes being further provided at one end with an adjustment member for adjusting spray angles of said jet nozzles of said spray tubes.

2. The prostrate water sprinkler as defined in claim 1, wherein said base is provided with a water distributing valve in communication with said hose connector and said two spray tubes.

3. The prostrate water sprinkler as defined in claim 1, wherein said two spray tubes are provided with a plurality of jet nozzles which are arranged in two rows along the longitudinal direction thereof such that jet nozzles of one row are different in spray angle from jet nozzles of another row.

4. The prostrate water sprinkler as defined in claim 1, wherein said two locating members are provided with a stop block extending therefrom; wherein said two adjustment members of said two spray tubes are provided with a lug corresponding in location to said stop block of said locating members whereby said lug is stopped by said stop block at such time when said spray tubes are turned a predetermined angle by said adjustment members.
